(19) United States
(12) Patent Application Publication
(10) Pub. No.: US 2018/0034327 A1
(43) Pub. Date: Feb. 1, 2018

(54) WIRELESS POWER TRANSFER ADAPTOR

(71) Applicant: PowerbyProxi Limited, Freemans Bay, Auckland (NZ)

(72) Inventors: Saining REN, Freemans Bay, Auckland (NZ); Zachary Strachan HARRIS, Freemans Bay, Auckland (NZ); Burt John OLIVER, Freemans Bay, Auckland (NZ)

(73) Assignee: PowerbyProxi Limited, Freemans Bay, Auckland (NZ)

(21) Appl. No.: 15/554,953

(22) PCT Filed: Mar. 4, 2016
(86) PCT No.: PCT/NZ2016/050035

§ 371 Date: Aug. 31, 2017

Related U.S. Application Data
(60) Provisional application No. 62/180,420, filed on Jun. 16, 2015.
(60) Provisional application No. 62/129,214, filed on Mar. 6, 2015.

(51) Int. Cl. H02J 50/90; H02J 50/12; H02J 7/02; H01F 38/14

(52) U.S. Cl. CPC H02J 50/90; H01F 38/14; H02J 50/12; H02J 7/025

(57) ABSTRACT

A wireless power transfer system comprising: a wireless power transfer transmitter having at least one power transmitting coil aligned in a first plane; a wireless power transfer receiver having at least one power receiving coil aligned in a second plane, the first and second planes being non-parallel to one another; and a wireless power transfer adaptor for adapting the power transferred in the first plane to power transferred in the second plane.

### FIELD OF THE INVENTION

The present invention is in the field of wireless or inductive power transfer. More particularly, but not exclusively, the present invention is directed to systems and methods for inductive power transfer for consumer electronic devices.

### BACKGROUND OF THE INVENTION

IPT technology is an area of increasing development and IPT systems are now utilised in a range of applications and with various configurations. One such application is the use of IPT systems in so called ‘charging mats’ or pads. Such charging mats will normally provide a planar charging surface onto which portable electronic devices (such as smartphones) may be placed to be charged or powered wirelessly.

Typically, the charging mat will include a transmitter having one or more power transmission coils arranged parallel to the planar charging surface of the charging mat. The transmitter drives the transmitting coils so that the transmitting coils generate a time-varying magnetic field in the immediate vicinity of the planar surface. When portable electronic devices are placed on or near the near the planar surface, the time-varying magnetic field will induce an alternating current in the receiving coil of a suitable receiver associated with the device (for example a receiver incorporated into the device itself). The received power may then be used to charge a battery, or power the device or some other load.

A problem associated with charging mat design is ensuring that the inductive power transfer is adequately efficient for different orientations of receiving coils. That is, for planar or flat devices, such as smartphones, the receiving coil associated with the device will typically be placed in a parallel plane to the transmitting coil(s) by being placed on the interface surface of the charging mat such that coupling is maximised and therefore power transfer is reasonably efficient. However, for non-planar or arbitrarily shaped devices, such as wearable devices, the receiving coil(s) associated with the device may be placed at a arbitrary angle or orientation relative to the transmitting coil(s) of the charging mat because the device itself may not sit flat on the interface surface of the charging mat. This situation may also occur for planar devices if a user wishes to orient the device for ease of use during charging/powering, e.g., the user props the device at an angle to the interface surface so that a screen of the device can be interacted with. Thus, without requiring device designers to provide ‘flat’ exterior surfaces for the coupling with the receiving coils or forcing users to not deviate from a co-planar orientation of their device, the efficiency of wireless power transfer may be significantly deteriorated, thereby limiting the applicable uses of charging mats.

Another problem associated with charging mat design is enabling multiple devices to be charged simultaneously in an efficient and cost effective manner. Some conventional designs use a single large transmitting coil corresponding to the entire surface of the charging mat. In this instance, one or more devices may be placed anywhere on the surface of the charging mat. This allows more freedom in terms of where a user may place a device on the charging mat. However, the magnetic field produced by a large transmitting coil may not be uniform, with ‘weak spots’ towards the centre of the charging mat, and the problems with arbitrary receiving coil orientation are not ameliorated. Further, since the entire surface is being ‘powered’ it is possible that any portions of the surface not covered by a device being charged may be a safety hazard.

Another conventional approach for multi-device charging is to have an array of transmitting coils. In order to provide efficient and safe power transfer, the charging mat detects the position of the devices using a suitable detection mechanism and activates the most proximate transmitting coil or coils. Though this allows more freedom in terms of where a user may place a device, like the single coil design, the boundary between adjacent transmitting coils can result in weak spots due to the cancelling effects of adjacent coils whereby receivers do not receiver sufficient power, and the problems with arbitrary receiving coil orientation are not ameliorated.

The invention provides an inductive power transfer system and methods that achieve reliable and efficient wireless power transfer for arbitrarily placed and orientated device powering or at least provides the public with a useful choice.

### SUMMARY OF THE INVENTION

According to one exemplary embodiment there is provided a wireless power transfer system comprising:
a wireless power transfer transmitter having at least one power transmitting coil aligned in a first plane;
a wireless power transfer receiver having at least one power receiving coil aligned in a second plane, the first and second planes being non-parallel to one another; and
a wireless power transfer adaptor for adapting the power transferred in the first plane to power transferred in the second plane.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning, i.e., they will be taken to mean an inclusion of the listed components which the use directly references, and possibly also of other non-specified components or elements.

Reference to any prior art in this specification does not constitute an admission that such prior art forms part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention.

FIG. 1 is a block diagram of a wireless power transfer system;

FIG. 2 illustrates an example application of the wireless power transfer system with a power transfer adaptor;

FIG. 3 illustrates another example application of the wireless power transfer system with example configurations of the power transfer adaptor;

FIGS. 4A and 4B are isolated views of one example configuration of the power transfer adaptor;

FIG. 5 is a block diagram of a wireless power transfer system having the wireless power transfer adaptor;

FIG. 6 is a conceptual view of the internal components of the wireless power transfer adaptor;

FIG. 7 is an isolated view of another example configuration of the power transfer adaptor;

FIGS. 8A-8C are isolated views of another example configuration of the power transfer adaptor;

FIGS. 9A and 9B are conceptual views of example configurations of internal components of the wireless power transfer adaptor;

FIGS. 10A-10G are a number of exemplary body geometries for a wireless power transfer adapter;

FIG. 11 illustrates an example application of a wireless power transfer system according to a further example configuration;

FIG. 12 is an isolated view of the further example configuration of the power transfer adaptor;

FIG. 13 is also an isolated view of the further example configuration of the power transfer adaptor;

FIG. 14 is conceptual view of the internal components of a further example configuration of the power transfer adaptor;

FIG. 15 is a side view of the wireless power transfer system according to a further example configuration;

FIG. 16 is conceptual view of the internal components of a yet further example configuration of the power transfer adaptor;

FIG. 17 illustrates an example application of the wireless power transfer system according to a yet further example configuration;

FIG. 18 illustrates another example application of the wireless power transfer system according to a yet further example configuration;

FIG. 19 illustrates a further example application of the wireless power transfer system according to a yet further example configuration; and

FIG. 20 illustrates a yet further example application of the wireless power transfer system according to a yet further example configuration.

### DETAILED DESCRIPTION OF EMBODIMENTS OF THE INVENTION

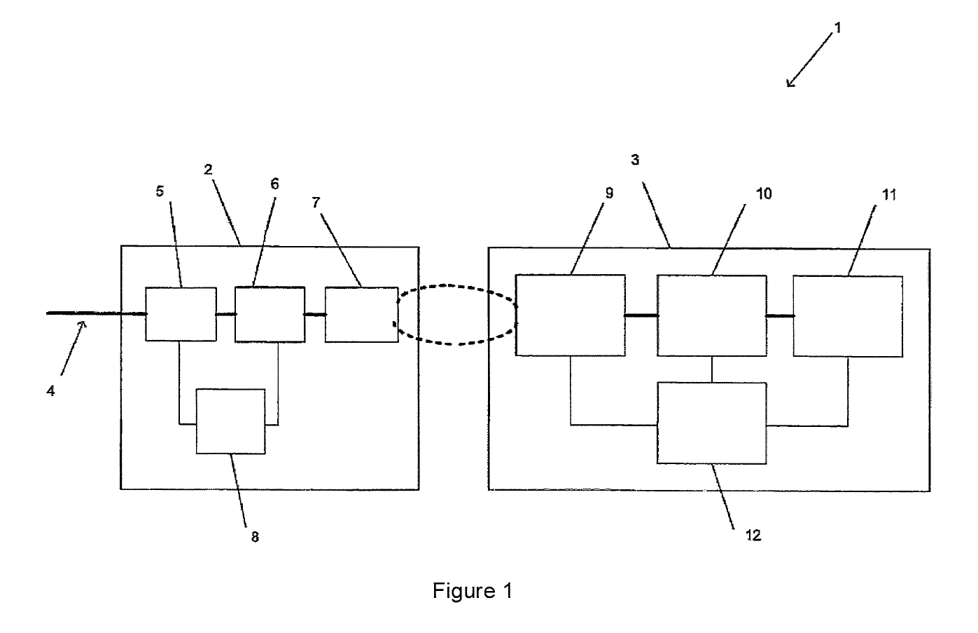

An inductive power transfer (IPT) system 1 is shown generally in FIG. 1. The IPT system includes an inductive power transmitter 2 and an inductive power receiver 3. The inductive power transmitter 2 is connected to an appropriate power supply 4 (such as mains power or a battery). The inductive power transmitter 2 in the form of a charging mat as described in the background may include transmitter circuitry having one or more of a converter 5, e.g., an AC-DC converter (depending on the type of power supply used) and an inverter 6, e.g., connected to the converter 5 (if present). The inverter 6 supplies a transmitting coil or coils 7 with an AC signal so that the transmitting coil or coils 7 generate an alternating magnetic field. In some configurations, the transmitting coil or coils 7 may be separate from the inverter 6. The transmitting coil or coils 7 may be connected to capacitors (not shown) either in parallel or series to create a resonant circuit.

A controller 8 is provided to control operation of the inductive power transmitter 2 and may be directly or indirectly connected to several or all parts of the transmitter 2. The controller 8 receives inputs from the various operational components of the inductive power transmitter 2 and produces outputs that control that operation. The controller 8 may be implemented as a single unit or separate units, configured to control various aspects of the inductive power transmitter 2 depending on its capabilities, including for example: power flow, tuning, selectively energising transmitting coil or coils 7, inductive power receiver detection and/or communications. Whilst the transmitter is depicted as a charging mat or device, other configurations are possible in the scope of the present invention, such as a transmitter integrated into the surfaces of non-device objects, such as bench tops or desk tops of furniture, and the interiors of motor vehicles.

The inductive power receiver 3 includes a power pick-up stage 9 connected to power conditioning circuitry 10 that in turn supplies power to a load 11. The load may be an electrically operational part of an electronic device or machine, or may be one or more power storage elements. The power pick-up stage 9 includes an inductive power receiving coil or coils. When the coil(s) of the inductive power transmitter 2 and the inductive power receiver 3 are suitably coupled, the alternating magnetic field generated by the transmitting coil or coils 7 induces an alternating current in the receiving coil or coils. The receiving coil or coils may be connected to capacitors and additional inductors (not shown) either in parallel, series or some other combination, such as inductor-capacitor-inductor, to create a resonant circuit. In some inductive power receivers, the receiver may include a controller 12 which may control tuning of the receiving coil or coils, operation of the power conditioning circuitry 10, characteristics of the load 11 and/or communications.

The term “coil” may include an electrically conductive structure where an electrical current generates a magnetic field. For example inductive “coils” may be electrically conductive wire in three dimensional shapes or two dimensional planar shapes, electrically conductive material fabricated using printed circuit board (PCB) techniques into three dimensional shapes over plural PCB ‘layers’, and other coil-like shapes. Other configurations may be used depending on the application. The use of the term “coil”, in either singular or plural, is not meant to be restrictive in this sense.

Current induced in the power pick-up stage 9 by transmitting coil or coils 7 will typically be high frequency AC at the frequency of operation of the transmitting coil or coils 7, which may be for example, 20 kHz, up to hundreds of megahertz or higher. The power conditioning circuitry 10 is configured to convert the induced current into a form that is appropriate for powering or charging the load 11, and may perform for example power rectification, power regulation, or a combination of both.

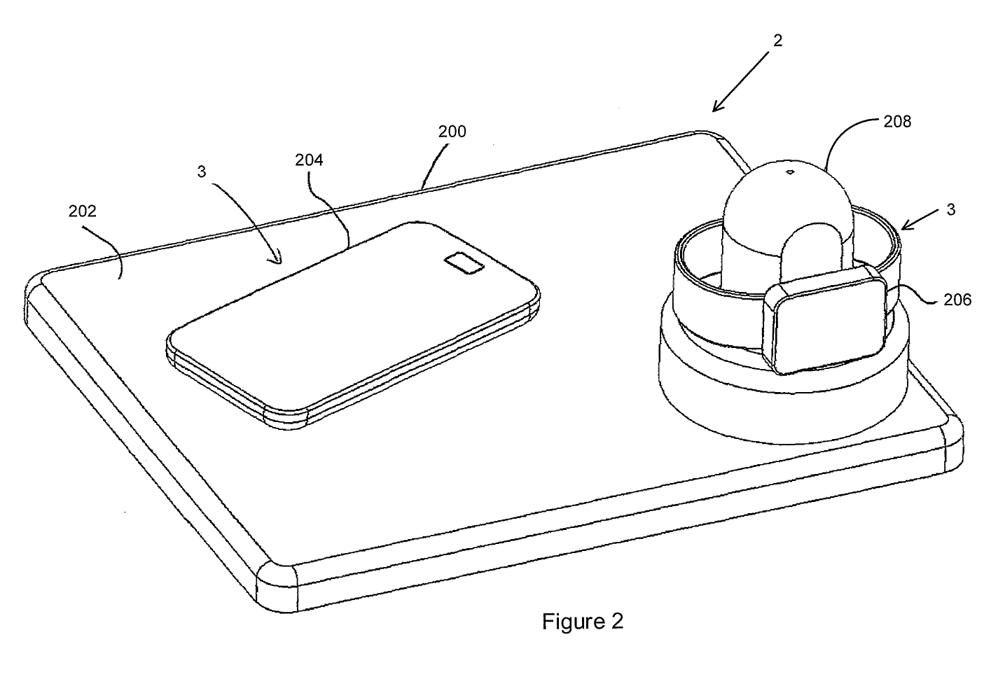

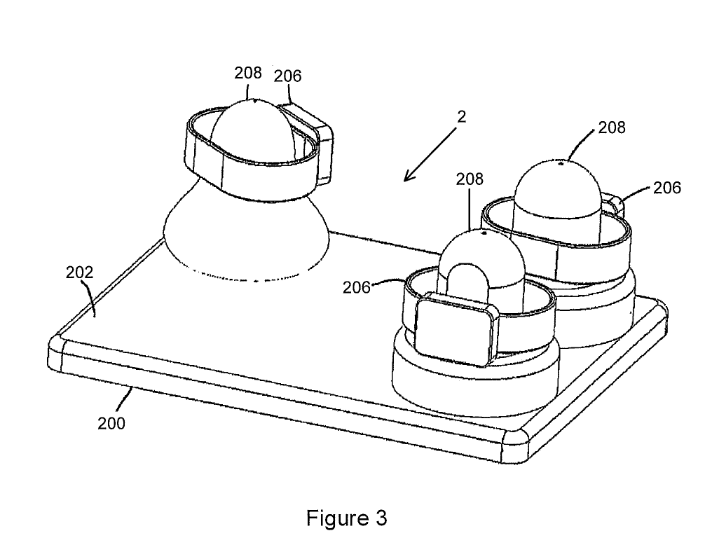

FIGS. 2 and 3 illustrate depictions of example applications of an IPT system according to the present invention. In these applications the power transmitter 2 is provided as a charging pad or mat 200 having one or more transmitting coils 7 arranged in a plane parallel to an interface surface 202 of the mat 200 onto which one or more power receiver devices 3 can be placed. In the example of FIG. 2, two receiver devices 3 are to be powered/charged by the transmitter mat 200, where one device is consumer electronic device 204, depicted as a smartphone, which has circuitry of the power receiver 3 integrated therewith or connected in some other way, e.g., via an “after-market” cover or device. The receiving coil(s) 9 of the device 204 are generally positioned so that they are in a parallel plane with the transmitting coil(s) in the orientation depicted in FIG. 2. The other receiver device is an arbitrary consumer electronic device 206, depicted as a wearable device or smartwatch, which has circuitry of the power receiver 3 integrated therewith such that the receiving coil(s) 9 of the device 206 are generally positioned so that they may not be in a parallel plane with the transmitting coil(s) if placed directly on the interface surface 202.

In order to ensure maximum power transfer efficiency to the arbitrary receiver device 206 the present invention further provides a power transfer adaptor 208 which functions to reorient the power transferring field of the power transmitter for full receipt by the receiver circuitry of the device 206. In FIG. 2, the power transfer adaptor 208 is depicted as a ‘stand’ for the wearable device 206. FIG. 3 depicts multiple examples of possible configurations of the stand 208 holding or supporting the wearable device 206, which are discussed in more detail later. The actual configuration, e.g., the exterior shape, dimensions and aspect of the adaptor unit 208 is not limited to this however, and depends on the type of receiver device to which power transfer is to be adapted. Some further examples of these applications are discussed in more detail later.

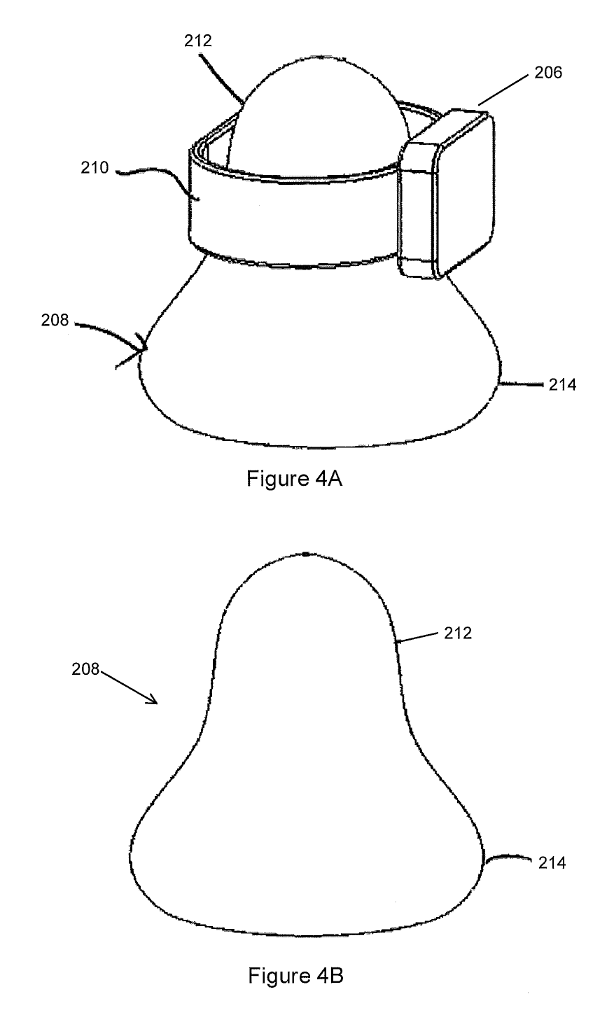

FIGS. 4A and 4B illustrate one of the example adaptor units 208 supporting the wearable device 206 and in isolation. As can be seen the general curved shape of the unit 208 is configured so that a strap 210 of the wearable device 206 is received over a neck portion 212 of the unit 208 so as to be supported against a body portion 214. The interior of the adaptor unit 208 houses wireless power transfer transceiver electronics for receiving power transferred from the transmitter 2 and transferring that received power to the receiver 3.

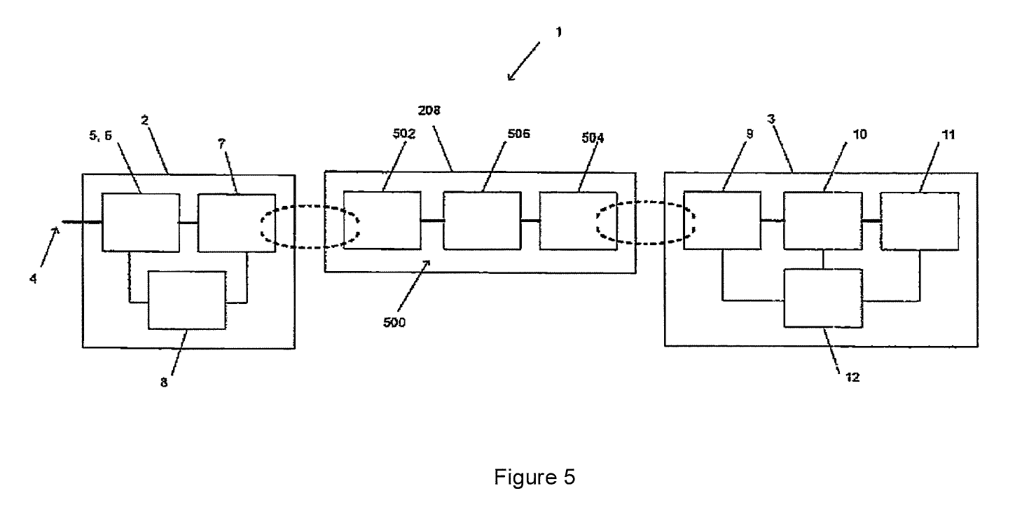

Example transceiver electronics 500 of the adaptor unit 208 are depicted in block diagram form in FIG. 5 relative the block diagram forms of the transmitter 2 and receiver 3 depicted for the IPT system 1 in FIG. 1. The adaptor electronics 500 includes a power pick-up stage 502 and a power transmitting stage 504 connected to one another via a connection stage 506. The power pick-up stage 502 includes one or more inductive power receiving coils. When the coil(s) of the inductive power transmitter 2 and receiving coil(s) the adaptor unit 208 are suitably coupled, the alternating magnetic field generated by the transmitting coil(s) 7 induces an alternating current in the receiving coil(s) of the adaptor unit 208. The receiving coil(s) may be connected to capacitors and additional inductors (not shown) either in parallel, series or some other combination, such as inductor-capacitor-inductor, to create a resonant circuit. The connection stage 506 may include power conditioning and/or control circuitry for conditioning the power received from the power transmitter and/or controlling tuning of the receiving coil(s), operation of the power conditioning circuitry and/or communications.

The power received by the power pick-up stage 502 is transferred to the power transmitting stage 504 via the connection stage 506. This power is supplied to one or more transmitting coils of the power transmitting stage 504, and as the power received by the power pick-up stage 502 represents an AC signal, this AC signal is conveyed to the transmitting coil(s) thereby generating an alternating magnetic field so that when the coil(s) of the inductive power receiver 3 and the transmitting coil(s) of the adaptor unit 208 are suitably coupled, the alternating magnetic field generated by the transmitting coil(s) induces an alternating current in the receiving coil(s) of the receiver 3. The transmitting coil(s) may be connected to capacitors and additional inductors (not shown) either in parallel, series or some other combination, such as inductor-capacitor-inductor, to create a resonant circuit. The connection stage 506 may include power conditioning and/or control circuitry for conditioning the power conveyed to transmitting coil(s) of the adaptor unit and/or controlling tuning of the transmitting coil(s), operation of the power conditioning circuitry and/or communications.

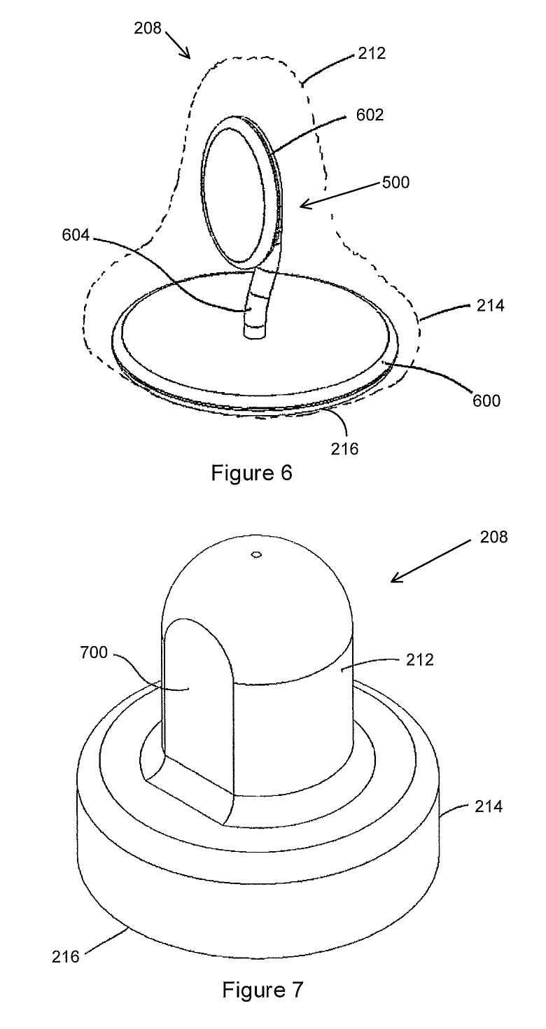

In the simplest form, the connection stage 506 is merely a conductive path between the receiving coil(s) and transmitting coil(s), so that minimal power is lost. This is depicted in conceptual form in FIG. 6. In FIG. 6, the exterior body of the adaptor unit 208 is shown in transparent form to reveal the transceiver electronics 500 within the unit 208. The power pick-up stage 502 is depicted as a single receiver coil 600 and the power transmitting stage 504 is depicted as a single transmitter coil 602. The coils are connected to one another via a single conductive wire 604 of the connection stage 506. As can be seen the transmitting coil 602 is orientated at a non-co-planar angle to the receiving coil 600. In the example of FIG. 6 the transmitting coil 602 is substantially orthogonal to the receiving coil 600. In this way, when the adaptor unit 208 is placed on the interface surface of the transmitter 2, the receiving coil 600 located at a base portion 216 of the unit 208 will be in a parallel plane with one or more transmitting coils 7 of the transmitter 2 thereby allowing maximum coupling (i.e., because there is maximum interaction with the magnetic field of the transmitting coils 7 of the transmitter 2 by the receiving coil 600 such that maximum magnetic flux is induced). On the other hand, when the wearable device 206 is placed on the adaptor unit 208 in a manner like that depicted in FIG. 4A, for example, the transmitting coil 602 located in the neck portion 212 of the unit 208 will be in a parallel plane with receiving coil(s) 9 of the receiver 3 thereby allowing maximum coupling (i.e., because there is maximum interaction with the magnetic field of the transmitting coils 602 by the receiving coil(s) 9 such that maximum magnetic flux is induced).

The adaptor receiving and transmitting coils depicted in conceptual form herein, are generally comprised of a spirally wound coil of conductive material on a supporting plate of magnetically permeable material, such as a ferrite. However, as described earlier other ‘coil’ configurations are possible. The magnetically permeable material enhances the coupling of the adaptor coils to the external coils of the transmitter and receiver devices. The magnetically permeable material is further positioned within the adaptor unit so that the adaptor receiving and transmitting coils are suitably decoupled from one another, thereby ensuring no interference between the coils. The adaptor coils may be similarly shielded from other electronics within the adaptor unit and or the external environment.

In the example depicted in FIG. 6, where a single planar transmitting coil 602 is provided in the adaptor unit 208, it is necessary for the wearable device 206 to be positioned so that its receiving coil(s) is properly aligned with the transmitting coil of the adaptor unit to allow maximum power transfer. This could be done by provided suitable marking on the adaptor unit to designate the location of the coil. Alternatively, the neck portion 212 can be configured to allow inherent alignment. This is depicted in FIG. 7, where a ‘flat’ facet 700 is provided on the neck portion 212 onto which a ‘flat’ surface of the wearable device aligned with the receiving coil thereof nests, as illustrated in FIG. 3.

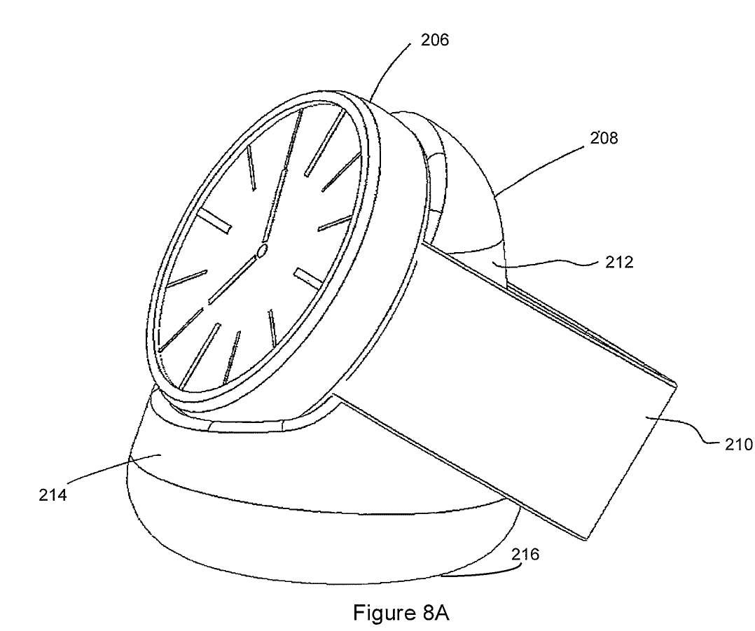

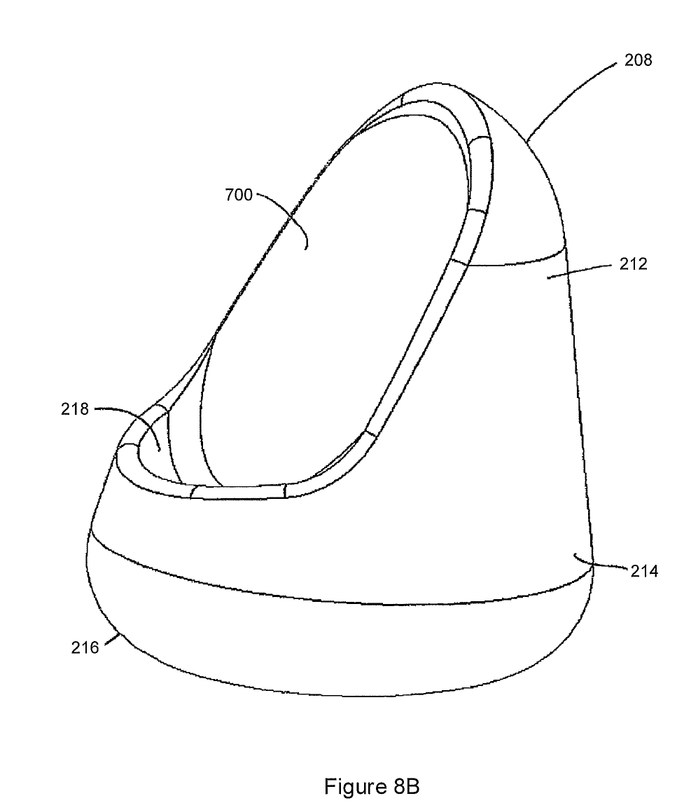

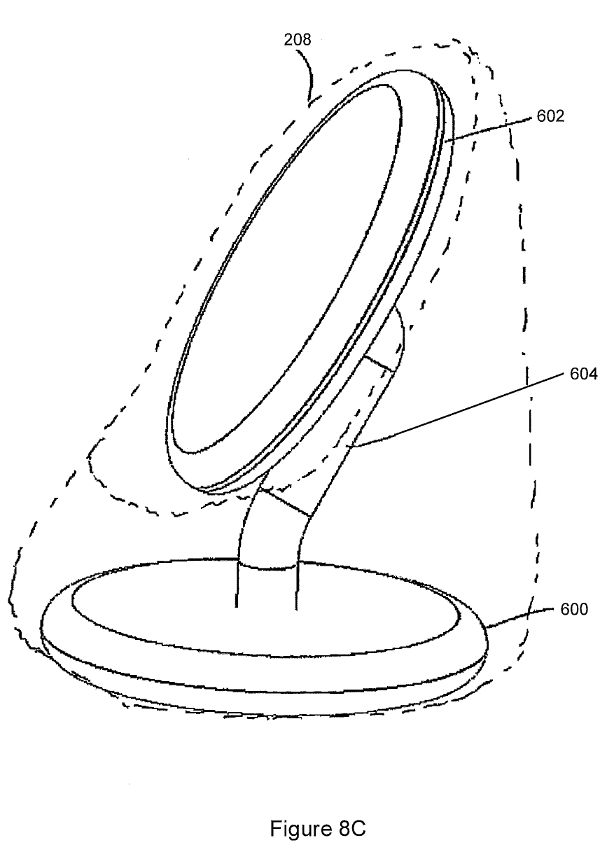

FIGS. 8A to 8C illustrate another example configuration of the adaptor 208 for providing ease for a user in correctly positioning the wearable device 206. In this example configuration, as illustrated in FIG. 8B, the flat facet 700 is provided at an angle to the base 216 of the unit 208 and the body portion 214 has a seat portion 218 configured to receive an watch segment of the smartwatch 206 depicted which has a receiving coil therein. This arrangement ensures that a user positions the smartwatch for maximum power transfer efficiency. Due to the non-orthogonal orientation of the facet or adaptor interface surface 700, the adaptor transmitting coil 602 is similarly arranged to be non-orthogonally aligned, but angled, to the base 216 (and the adaptor receiving coil 600), so that the adaptor transmitting coil is in a parallel plane to the adaptor interface surface, as illustrated in FIG. 8C. With this angled configuration of the adaptor unit which provides an angled relative orientation of the charging mat and the receiving coils of the receiver device, not only wearable devices can be supported in this relationship, but other devices as well, such as smartphones, such that interaction with the receiver device by users during powering/charging via the adaptor can be easily enabled.

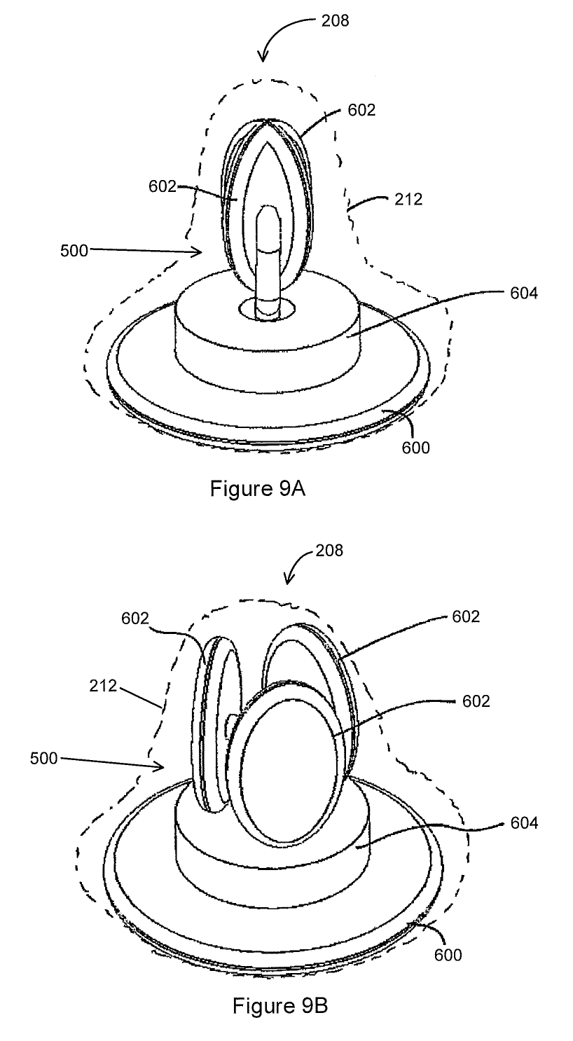

Further ease for a user however can be provided by configuring the transceiver electronics of the adaptor unit 208 so that multiple power transmission planes are provided. To this end, FIGS. 9A and 9B depict example configurations of the adaptor electronics 500 having multiple transmitting coils 602. In FIG. 9A, two transmitting coils 602 are arranged orthogonal to one another such that two magnetic fields (or actually four magnetic fields) are induced 90 radian degrees out of phase with one another, such that the magnetic fields due not interfere with one other through cross-coupling of the coils. In FIG. 9B, three transmitting coils are arranged about the neck portion 212 such that three magnetic fields are induced, with cross-coupling avoided by arranging ferrite material behind each coils with respect to the interior of the neck portion. These arrangements provide a power transfer field having a larger range than the single planar coil example thereby be providing substantially free placement of the receiver device.

In the multiple transmitting coil embodiments of the adaptor unit, the plural transmitting coils may be simultaneously operated through constant connection to the adaptor receiving coil(s) via the connection stage, or operation may be selective. Selective operation may be provided by suitable switching control in the electronics of the connection stage 506 so that only selected adaptor transmitting coils are connected to the adaptor receiving coil at any time. This selection could be controlled using a suitable controller, such as a digital controller in the form of a programmable integrated circuit, e.g., a microcontroller, or as an analog controller in the form of discrete circuit components.

Selection of the adaptor transmitting coil or coils required to transfer power to a proximate receiver device could be governed by suitable detection of the proximity of the receiver device. This can be achieved, for example, using suitable sensors or detection techniques within the adaptor electronics. As one example, the Applicant has found that receiver devices which generally include ferrite in conjunction with the receiving coils provide reflected impedance characteristics which are different to objects having metal only, e.g., little or no magnetically permeable material. This situation can therefore be used to detect the presence of a receiver object, and power transfer can be established based on this or on further detection techniques, such as analogue or digital communications with applicably capable receiver devices. Indeed, depending of the type of charging mat that the adaptor unit is placed upon, the presence of the adaptor unit itself can be ascertained by the power transmitter using a similar technique, since the adaptor unit has ferrite associated with the base coil 600. Further, in IPT systems in which communications between transmitter and receiver devices is implemented using the IPT field itself, e.g., through amplitude, frequency and/or phase modulation of the IPT field, such communication can be carried out through the transceiver network of the adaptor unit. Further, the transceiver electronics of the adaptor itself can be provided with suitable modulation/demodulation circuitry to allow independent communications with the transmitter and receiver devices, thus allowing establishment of ‘power contracts’ between the adaptor and power transmitter and/or between the adaptor and the power receiver.

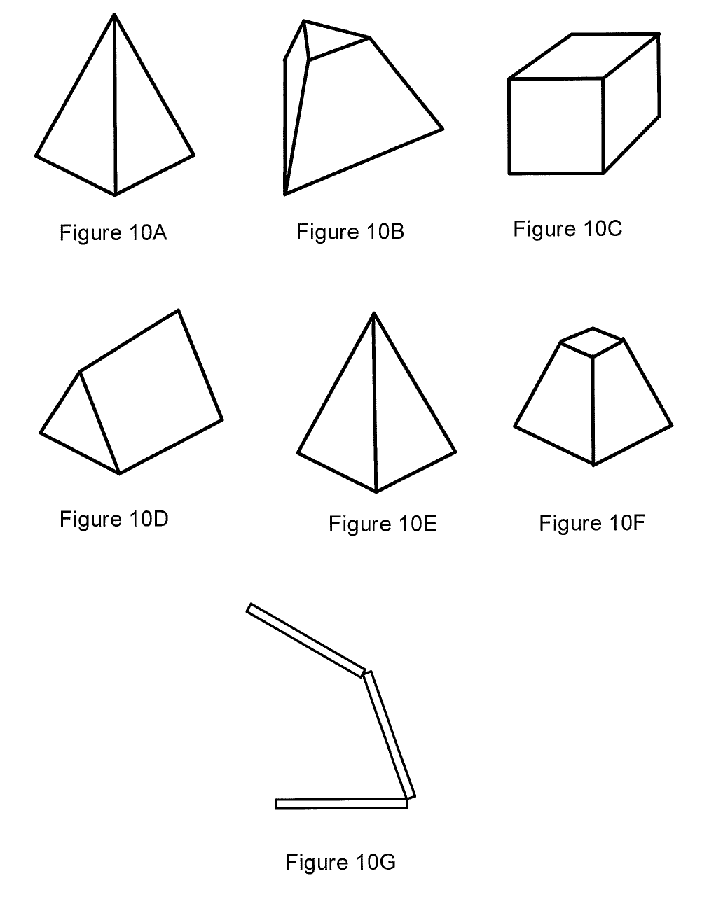

FIGS. 10a to 10g show a number of exemplary body geometries for a wireless power transfer system utilising flat surfaces having coils adjacent a plurality or each flat surface. Possible geometries include a triangular based pyramid (FIG. 10a), a frusto triangular based pyramid (FIG. 10b), a cube (FIG. 10c), a triangular prism (FIG. 10d), a square based pyramid (FIG. 10e), a frusto square based pyramid (FIG. 10f) or articulated planar sections (FIG. 10g). Flat surfaces have the advantage that they closely conform to planar interface surfaces of devices to be charged as well as the charging pad. This also allows wireless power transfer systems to be stacked for geometries such as a cube.

In some embodiments one or more coil may be dedicated receive coils and one or more coils may be dedicated transmit coils. In a preferred embodiment each flat face may have an associated coil proximate the face that may be dynamically configured to be a receive or a transmit coil based on monitoring of the coils by a wireless power transfer adaptor of the wireless power transfer system. The wireless power transfer adaptor may monitor the coils and upon detecting a coil receiving power may configure that coil to be a power receiving coil. The wireless power transfer adaptor may then monitor the other coils to determine if there is a device proximate one of the other coils demanding power and configure that coil as a power transmitting coil. The transmitter coil configuration may also be performed based on communication between the wireless power transfer adaptor and a device to be charged.

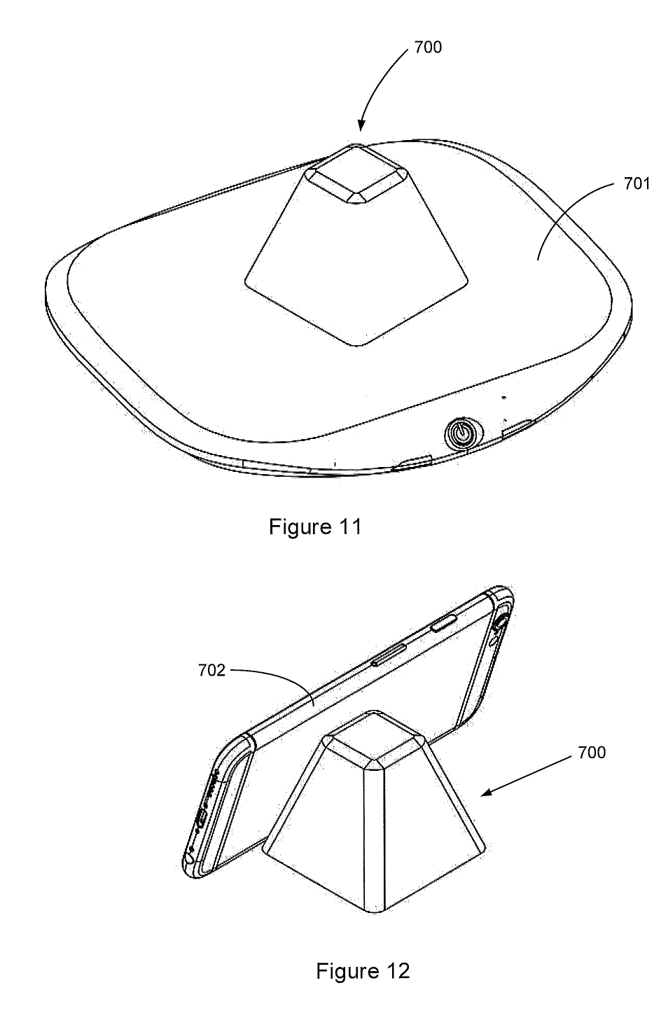

Referring to FIGS. 11 to 14 a wireless power transfer system 700 having a frustopyrimidal body is shown. In this case the base 705 has a dedicated receiver coil 710 located adjacent base 705 and four transmit coils 706 to 709 located adjacent flat side faces 711 to 714. The flat base may be positioned adjacent the surface of charging pad 701 for good coupling.

As shown in FIG. 12 a device such as a tablet 702 may be positioned in an inclined manner against wireless power transfer system 700 so that it is well oriented for a user to use the device during charging as well as to position a transmitter coil of the wireless power transfer system 700 optimally with respect to the flat face of tablet 702.

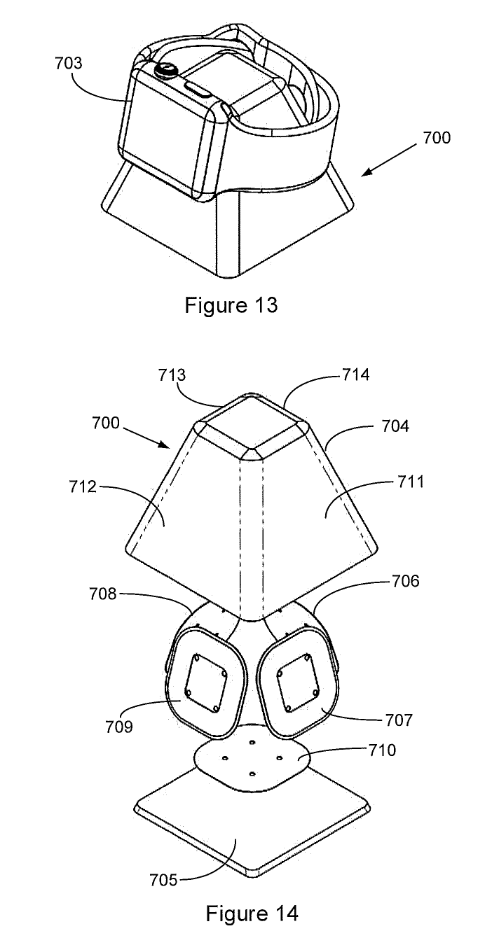

As shown in FIG. 13 a watch 703 may be simply placed on wireless power transfer system 700 and the flat back of the watch will automatically position itself against a flat face of wireless power transfer system 700 to provide good coupling between the transmit coil of wireless power transfer system 700 and the receive coil of watch 703. The tapering shape also ensures that a watch will be easily placed and retained in the correct position on wireless power transfer system 700.

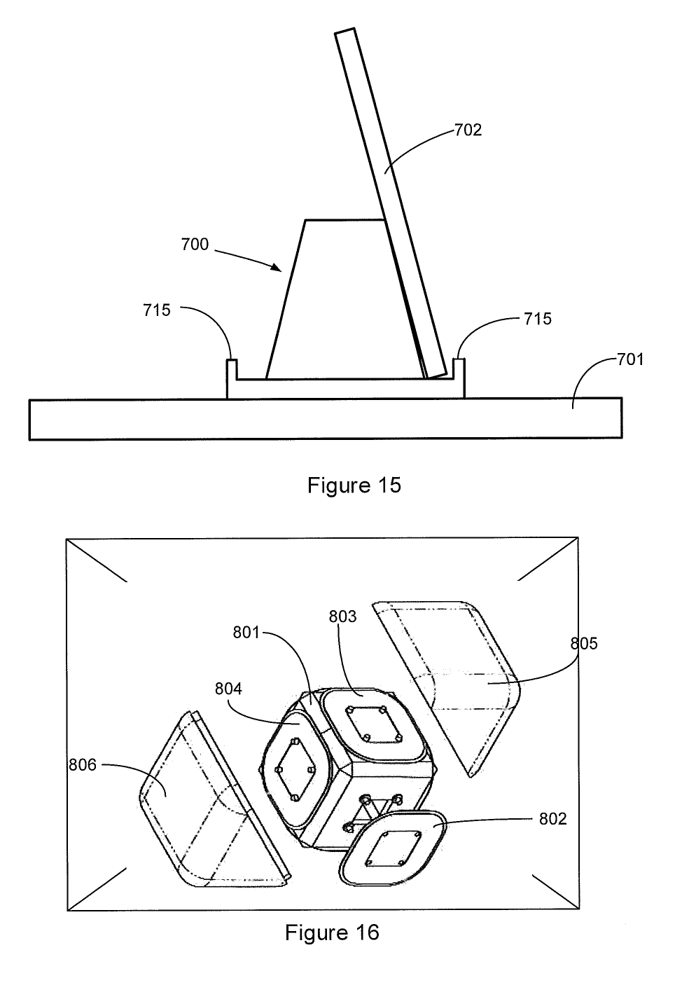

FIG. 15 shows a modified version in which wireless power transfer system 700 includes feet 715 to retain the bottom edge of tablet 702.

FIGS. 16 to 19 show an embodiment in which the wireless power transfer system 800 is in the form of a cube. As shown in FIG. 15 an inner cube 801 has coils 802 to 804 mounted to each face (as well as three more coils on the faces not visible). A wireless power transfer adaptor is located within inner cube 801 and is electrically connected to all coils. In this embodiment the coils are configurable to be transmit or receive coils as will be explained. The outer casing is formed by two halves 805 and 806 that join to encase the other components.

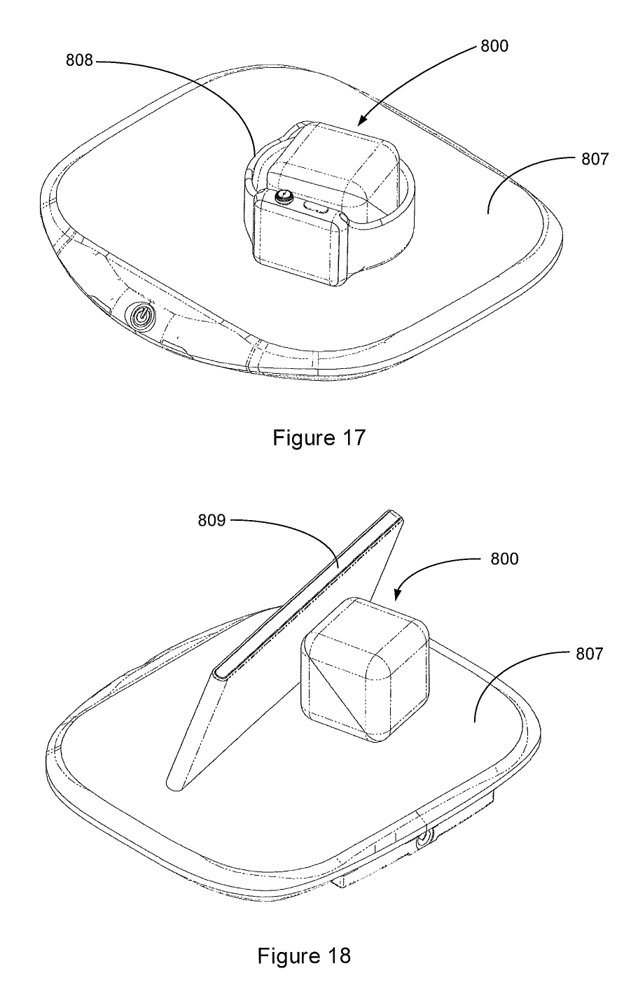

As shown in FIG. 17 a wireless power transfer system in the form of a cube 800 may be placed on a charging pad 807. The wireless power transfer adaptor within the cube detects power being received by the coil proximate the surface of the charging pad and configures it as a receiver coil. Watch 808 is then placed about the cube and the wireless power transfer adaptor detects that one of the other coils is proximate a device demanding power an configures that coil as a transmit coil. Alternatively the transmit coil could be configured as a result of communication—for example communication via the coil proximate the watch.

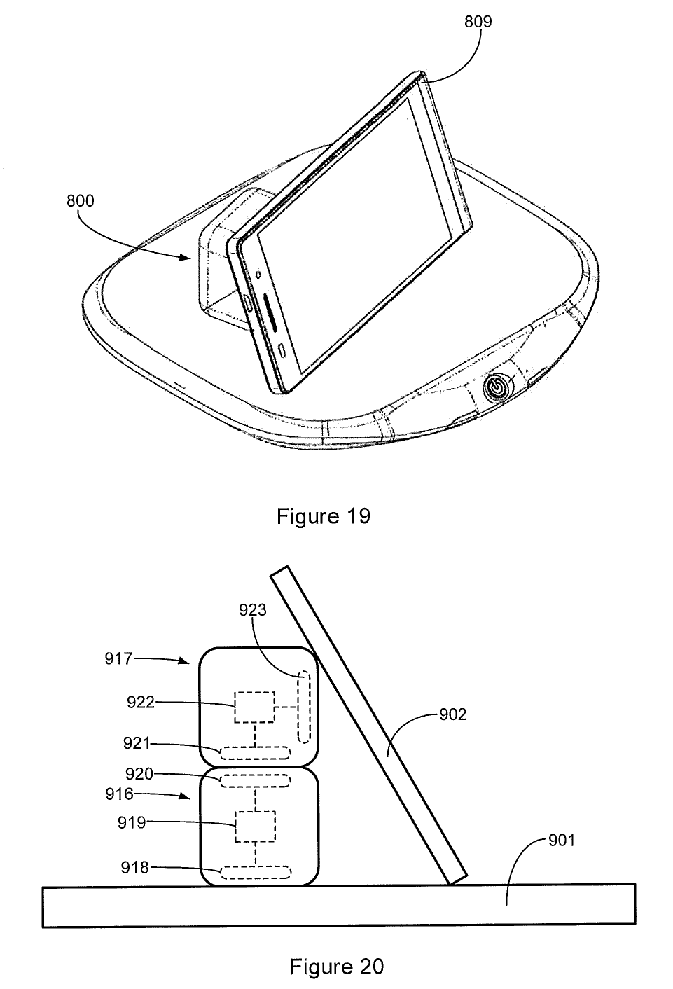

As shown in FIGS. 18 and 19 a tablet 809 may also be placed against the cube 800 to charge in a similar way. Coupling may be less optimal than for the embodiment of FIGS. 11 to 14 as the tablet is more inclined but the arrangement has advantages in terms of modularity as will be described below.

FIG. 20 illustrates how multiple cubes 900 may be employed as a modular repeater. In this case a first cube 917 is stacked upon a second cube 916 upon a charging pad 901. In this case wireless power transfer adaptor 919 configures coil 918 as the receive coil and coil 920 as the transmit coil and wireless power transfer adaptor 922 configures coil 921 as a receive coil and coil 923 as a transmit coil. This forms a two stage repeater from charging pad 901 to tablet 902. This may desirable depending upon the size of the device and position of the power receiving coil of the device to be charged. It will be appreciated that the cubes may be mechanically or magnetically locked together and/or provided with non-slide surfaces so as to provide a suitable support for a device.

In the afore-described example configurations of the wireless power transfer adaptor, the ‘body’ of the adaptor unit is rigid or static, meaning that the possible relative orientations of the interface surface of the transmitter and the receiver device are set. However, in a further example configuration of the adaptor unit, the body may be at least partly formed of a mouldable and conformable material. In this way, the adaptor body can be moulded and remoulded depending on application where the adaptor electronics within is flexible through, for example, a flexible connection stage 506. The mouldable material may be any suitable material that can be moulded to retain the moulded shape thereby providing structure for the desired form for the adaptor unit without interfering with operation of the encased electronics or with the inductive magnetic fields used by the system. Such material may be, for example, gel, polymer, clay or bendable plastic. The adaptor electronics may be embedded within the mouldable material, for example, by pouring or shaping the material about the electronics, or by having the material press- or snap-fitted about the internal components, which are held in place by the mouldable material itself or by adhesive or the like.

Whilst the present invention has been illustrated by the description of the embodiments thereof, and while the embodiments have been described in detail, it is not the intention to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the general inventive concept.

1. A wireless power transfer system comprising:
a wireless power transfer transmitter having at least one power transmitting coil aligned in a first plane;
a wireless power transfer receiver having at least one power receiving coil aligned in a second plane, the first and second planes being non-parallel to one another; and
a wireless power transfer adaptor for adapting the power transferred in the first plane to power transferred in the second plane.

2. A system according to claim 1, wherein the adaptor has at least one power receiving coil aligned in the first plane and at least one power transmitting coil aligned in the second plane.

3. A system according to claim 2, wherein the power receiving and transmitting coils of the adaptor are electrically connected via a connection stage.

4. A system according to claim 3, wherein the connection stage has control circuitry for conditioning the power transferred between the power receiving and transmitting coils of the adaptor.

5. A system according to claim 1, wherein the adaptor has transceiver circuitry housed within a body, the body being configured for receipt on an interface surface of the wireless power transfer transmitter.

6. A system according to claim 5, wherein the body of the adaptor is further configured to support the wireless power transfer receiver.

7. A system according to claim 6, wherein the body of the adaptor is formed of a mouldable material.

8. A system according to claim 5 wherein the body includes at least one flat surface proximate a power transmitting coil.

9. A system according to claim 5 wherein the body includes a plurality of flat surfaces.

10. A system according to claim 9 wherein a combined transmitter/receiver coil is provided proximate each flat surface.

11. A system according to claim 10 wherein the wireless power transfer adaptor monitors the transmitter/receiver coils and dynamically configures the transmitter/receiver coils into a transmitter coil and receiver coil pair.

12. A system according to claim 11 wherein the body includes 4 flat surfaces.

13. A system according to claim 12 wherein the body is a triangular based pyramid or a frusto triangular based pyramid.

14. A system according to claim 12 wherein the body is a triangular prism.

15. A system according to claim 11 wherein the body includes 5 flat surfaces.

16. A system according to claim 15 wherein the body is a square based pyramid or a frusto square based pyramid.

17. A system according to claim 11 wherein the body includes 6 flat surfaces.

18. A system according to claim 17 wherein the body is a cube.

19. A system as claimed in claim 11 wherein the body is in the form of a plurality of articulated panels.

20. A system as claimed in claim 12 including a supporting ledge extending from a flat face.
